(19) United States
(12) Patent Application Publication
(10) Pub. No.: US 2023/0182240 A1
(43) Pub. Date: Jun. 15, 2023

(54) Application of differential thermal contraction to obtain improved cryogenic interfacial contact

(71) Applicant: International Business Machines Corporation, Armonk, NY (US)

(72) Inventors: Shawn Hall, Pleasantville, NY (US); Robert Shelby, Boulder Creek, CA (US); Charles Rettner, San Jose, CA (US)

(21) Appl. No.: 17/644,443

(22) Filed: Dec. 15, 2021

(51) Int. Cl. B23P 11/02; F16B 1/00; F16B 4/00

(52) U.S. Cl. CPC B23P 11/025; F16B 1/00; F16B 4/006; F16B 2001/0078

(57) ABSTRACT

An apparatus comprising a first component comprised of a first material, wherein the first material has a first thermal contraction property. A second component comprised of a second material, wherein the second material has a second thermal contraction property, wherein the second component has an opening where a portion of the first component is inserted into at room temperature. Wherein the second thermal contraction property is larger than the first thermal contraction property and when at cryogenic temperatures, the first component and second component constrict, wherein the second component constricts more than the first component causing the second component to exert a constricting force on the portion of the first component inserted into the opening of the second component.

### STATEMENT REGARDING FEDERALLY SPONSORED RESEARCH OR DEVELOPMENT

This invention was made with U.S. Government support. The U.S. Government has certain rights in this invention.

### BACKGROUND

The present invention relates to fasteners, and more specifically, utilizing the thermal contraction of different materials to self-fasten at cryogenic temperatures.

The efficient design of systems for cryogenic applications requires the extraction of any heat produced. Extraction of heat across interfaces is proportional to the thermal conductance of the interface between them. It is therefore desirable to have a high thermal conductance of interfaces in the thermal path between the generated power and the cryogenic heat sink. It is well known that this conductance increases as the force between surfaces is raised. Such forces are conventionally applied by tightening screws or bolts. While high conduction can be obtained across interfaces using conventional clamping, such as with screws and bolts, this approach may not be practical, for example when other design constraints and considerations limit access to those components. Even when access to these components is possible, precise tightening of multiple components may be laborious and/or impractical.

### BRIEF SUMMARY

Additional aspects and/or advantages will be set forth in part in the description which follows and, in part, will be apparent from the description, or may be learned by practice of the invention.

An apparatus comprising a first component comprised of a first material, wherein the first material has a first thermal contraction property. A second component comprised of a second material, wherein the second material has a second thermal contraction property, wherein the second component has an opening where a portion of the first component is inserted into at room temperature. Wherein the second thermal contraction property is larger than the first thermal contraction property and when at cryogenic temperatures, the first component and second component constrict, wherein the second component constricts more than the first component causing the second component to exert a constricting force on the portion of the first component inserted into the opening of the second component.

An apparatus comprising a protrusion extending from a first component, wherein the protrusion of the first component is comprised of a first material, wherein the first material has a first thermal contraction property. A recessed area located in second component to receive the protrusion of the first component, wherein the second component is comprised of a second material, wherein the second material has a second thermal contraction property, wherein the second component has an opening where a portion of the first component is inserted into at room temperature. Wherein the second thermal contraction property is larger than the first thermal contraction property, and when at cryogenic temperatures, the first component and second component constrict, wherein the second component constricts more than the first component causing the second component to exert a constricting force on the portion of the first component inserted into the opening of the second component.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 represents a view depicting a clamping design, according to an example embodiment.

FIG. 2 represents a view depicting a clamping design, according to an example embodiment.

Elements of the figures are not necessarily to scale and are not intended to portray specific parameters of the invention. For clarity and ease of illustration, dimensions of elements may be exaggerated. The detailed description should be consulted for accurate dimensions. The drawings are intended to depict only typical embodiments of the invention, and therefore should not be considered as limiting the scope of the invention. In the drawings, like numbering represents like elements.

### DETAILED DESCRIPTION

Exemplary embodiments now will be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will convey the scope of this disclosure to those skilled in the art. In the description, details of well-known features and techniques may be omitted to avoid unnecessarily obscuring the presented embodiments.

For purposes of the description hereinafter, terms such as “upper”, “lower”, “right”, “left”, “vertical”, “horizontal”, “top”, “bottom”, and derivatives thereof shall relate to the disclosed structures and methods, as oriented in the drawing figures. Terms such as “above”, “overlying”, “atop”, “on top”, “positioned on” or “positioned atop” mean that a first element, such as a first structure, is present on a second element, such as a second structure, wherein intervening elements, such as an interface structure may be present between the first element and the second element. The term “direct contact” means that a first element, such as a first structure, and a second element, such as a second structure, are connected without any intermediary conducting, insulating or semiconductor layers at the interface of the two elements. As used herein, the term “same” when used for comparing values of a measurement, characteristic, parameter, etc., such as “the same width,” means nominally identical, such as within industry accepted tolerances for the measurement, characteristic, parameter, etc., unless the context indicates a different meaning. As used herein, the terms “about,” “approximately,” “significantly, or similar terms, when used to modify physical or temporal values, such as length, time, temperature, quantity, electrical characteristics, superconducting characteristics, etc., or when such values are stated without such modifiers, means nominally equal to the specified value in recognition of variations to the values that can occur during typical handling, processing, and measurement procedures. These terms are intended to include the degree of error associated with measurement of the physical or temporal value based upon the equipment available at the time of filing the application, or a value within accepted engineering tolerances of the stated value. For example, the term “about” or similar can include a range of ±8% or 5%, or 2% of a given value. In one aspect, the term “about” or similar means within 10% of the specified numerical value. In another aspect, the term “about” or similar means within 5% of the specified numerical value. Yet, in another aspect, the term “about” or similar means within 10, 9, 8, 7, 6, 5, 4, 3, 2, or 1% of the specified numerical value. In another aspect, these terms mean within industry accepted tolerances.

For the clarity of the description, and without implying any limitation thereto, illustrative embodiments may be described using simplified diagrams. In an actual fabrication, additional structures that are not shown or described herein, or structures different from those shown and described herein, may be present without departing from the scope of the illustrative embodiments.

Differently patterned portions in the drawings of the example structures, layers, and formations are intended to represent different structures, layers, materials, and formations in the example fabrication, as described herein. A specific shape, location, position, or dimension of a shape depicted herein is not intended to be limiting on the illustrative embodiments unless such a characteristic is expressly described as a feature of an embodiment. The shape, location, position, dimension, or some combination thereof, are chosen only for the clarity of the drawings and the description and may have been exaggerated, minimized, or otherwise changed from actual shape, location, position, or dimension that might be used in actual fabrication to achieve an objective according to the illustrative embodiments.

An embodiment when implemented in an application causes a fabrication process to perform certain steps as described herein. The steps of the fabrication process are depicted in the several figures. Unless such a characteristic is expressly described as a feature of an embodiment, not all steps may be necessary in a particular fabrication process; some fabrication processes may implement the steps in different order, combine certain steps, remove or replace certain steps, or perform some combination of these and other manipulations of steps, without departing the scope of the illustrative embodiments.

The illustrative embodiments are described with respect to certain types of materials, electrical properties, structures, formations, layers orientations, directions, steps, operations, planes, dimensions, numerosity, data processing systems, environments, and components. Unless such a characteristic is expressly described as a feature of an embodiment, any specific descriptions of these and other similar artifacts are not intended to be limiting to the invention; any suitable manifestation of these and other similar artifacts can be selected within the scope of the illustrative embodiments.

The illustrative embodiments are described using specific designs, architectures, layouts, schematics, and tools only as examples and are not limiting to the illustrative embodiments. The illustrative embodiments may be used in conjunction with other comparable or similarly purposed designs, architectures, layouts, schematics, and tools.

For the sake of brevity, conventional techniques related to microelectronic fabrication may or may not be described in detail herein. Moreover, the various tasks and process steps described herein can be incorporated into a more comprehensive procedure or process having additional steps or functionality not described in detail herein. In particular, various steps in the manufacture of microelectronic devices may be well known and so, in the interest of brevity, many conventional steps may only be mentioned briefly or may be omitted entirely without providing the well-known process details.

In the following descriptions, the term length applies to dimensional characteristics along the x-axis.

In the following descriptions, the term width applies to dimensional characteristics along the y-axis.

In the following descriptions, the term thickness applies to dimensional characteristics along the z-axis.

In the interest of not obscuring the presentation of embodiments of the present invention, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is rather focused on the distinctive features or elements of various embodiments of the present invention.

Various processes used to form a micro-chip that will be packaged into an integrated circuit (IC) fall into four general categories, namely, film deposition, removal/etching, semiconductor doping and patterning/lithography. Deposition is any process that grows, coats, or otherwise transfers a material onto the wafer. Available technologies include physical vapor deposition (PVD), chemical vapor deposition (CVD), electrochemical deposition (ECD), molecular beam epitaxy (MBE) and more recently, atomic layer deposition (ALD) among others. Removal/etching is any process that removes material from the wafer. Examples include etch processes (either wet or dry), and chemical-mechanical planarization (CMP), and the like. Semiconductor doping is the modification of electrical properties by doping, for example, transistor sources and drains, generally by diffusion and/or by ion implantation. These doping processes are followed by furnace annealing or by rapid thermal annealing (RTA). Annealing serves to activate the implanted dopants. Films of both conductors (e.g., poly-silicon, aluminum, copper, etc.) and insulators (e.g., various forms of silicon dioxide, silicon nitride, etc.) are used to connect and isolate transistors and their components. Selective doping of various regions of the semiconductor substrate allows the conductivity of the substrate to be changed with the application of voltage. By creating structures of these various components, millions of transistors can be built and wired together to form the complex circuitry of a modern microelectronic device.

Reference will now be made in detail to the embodiments of the present invention, examples of which are illustrated in the accompanying drawings, wherein like reference numerals refer to like elements throughout. The propose invention is a self-clamping method whereby the clamping force arises from the differential thermal contraction of component materials. Ideally, these components can be assembled and disassembled at room temperature with zero clamping. The propose invention takes advantage of the different thermal contractions of different materials. The clamping force arises from the shrinking of the outer material into the inner material, where the outer material shrinks more than the inner material.

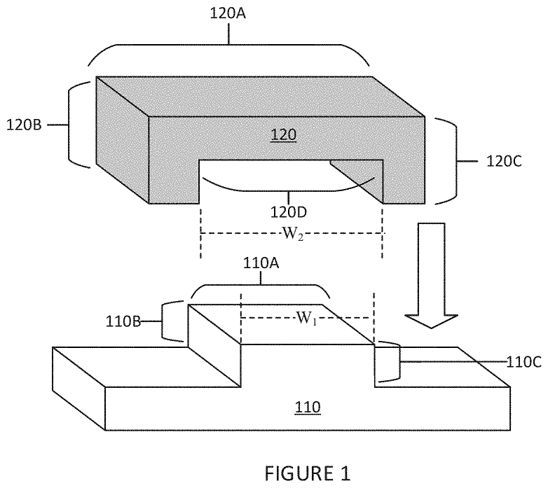

FIG. 1 represents a view depicting a fastener design, according to an example embodiment.

The self-clamping fastening system includes a first component 110 and a second component 120. The first component 110 is comprised of a first material and the second component is comprised of a second material. For example, the first material can be silicon, tungsten, niobium, or a different material. The second material can be, for example, copper, aluminum, or another suitable material. The first material and the second material are different and the thermal constriction properties of the material are different. As illustrated by FIG. 1, the second component 120 is the clamping component, thus the second material will need to have a higher thermal constriction property than the first material. This means at cryogenic temperature the second material will constrict more than the first material.

The first component 110 will have a protrusion that extends out of the first component 110. The protrusion will have two side sections 110B and 110C and have a top section 110A. The protrusion has a width W₁. The design of the protrusion as illustrated by FIG. 1 is for example purposes only. The protrusion can be circular, cylindrical, or any other shape. The second component 120 is designed to fit around at least three sides of the protrusion. As illustrated by FIG. 1, the second component 120 includes a flat section 120A, and two side sections 120B and 120C. The side sections 120B and 120C extend the opposite direction as the side sections 110B and 110C of the protrusion of the first component 110. A receiving section 120D is created by the flat section 120A and the side sections 120B and 120C. The receiving section 120D has a width W₂. The width W₂ is slightly larger than the width W₁, to allow the components to slide together at room temperature. As the components are cooled to cryogenic temperatures in the cryogenic refrigeration unit the first component 110 and the second component 120 will constrict. Since the second material constricts more than the first material, then the second component 120 will clamp on/fasten to the protrusion of the first component 110. This will provide a good contact area between the first component 110 and the second component 120, thus allowing for good thermal conductance between the components.

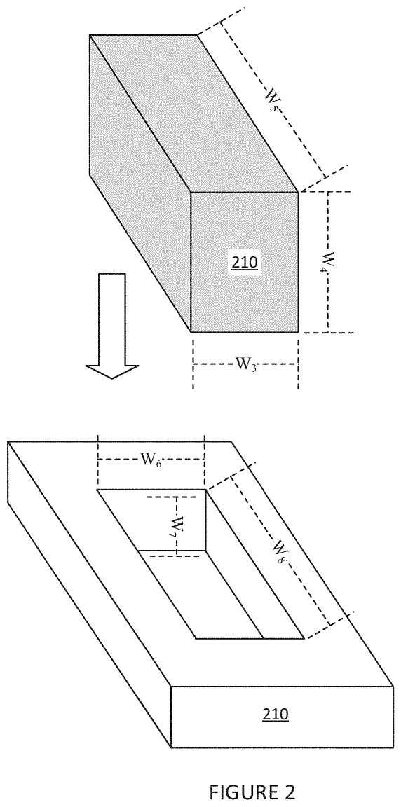

FIG. 2 represents a view depicting a clamping design, according to an example embodiment. FIG. 2 is similar to FIG. 1 in respect to the difference of materials. FIG. 1 illustrates clamping on three sides of the protrusion of the first component 110, while FIG. 2 illustrates clamping on four sides of a protrusion. The first component will have a protrusion 210 that extend out having a set dimension, for example, having a width W₃, a height W₄, and a depth W₅. The second component 220 will have a slot cut out in the component to receive the protrusion of the first component 210. The slot in the second component 220 will have a set of dimensions, for example, having a width W₆, a height W₇, a depth W₈. The dimensions of the slot in the second component 220 is slight larger than the dimension of the protrusion of the first component 210, to allow for the protrusion to be inserted into the slot when at room temperature. As the components are cooled to cryogenic temperatures in the cryogenic refrigeration unit the first component 210 and the second component 220 will constrict. Since the second material constricts more than the first material, then the second component 220 will clamp on/fasten to the protrusion of the first component 210. The second component 220 will constrict/clamp on to four sides of the protrusion of the first component 210. This will provide a good contact area between the first component 210 and the second component 220, thus allowing for good thermal conductance between the components.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. An apparatus comprising:
a first component comprised of a first material, wherein the first material has a first thermal contraction property; and
a second component comprised of a second material, wherein the second material has a second thermal contraction property, wherein the second component has an opening where a portion of the first component is inserted into at room temperature;
wherein the second thermal contraction property is larger than the first thermal contraction property;
when at cryogenic temperatures, the first component and second component constrict, wherein the second component constricts more than the first component causing the second component to exert a constricting force on the portion of the first component inserted into the opening of the second component.

2. The apparatus of claim 1, wherein the second component exerts a constricting force on three sides of the portion of the first component.

3. The apparatus of claim 1, wherein the second component exerts a constricting force on four sides of the portion of the first component.

4. The apparatus of claim 1, wherein the first material can be selected for a group consisting of Silicon, Tungsten, Niobium, or another suitable material.

5. The apparatus of claim 4, wherein the second material can be selected from a group consisting of Copper, aluminum, or another suitable material.

6. An apparatus comprising:
a protrusion extending from a first component, wherein the protrusion of the first component is comprised of a first material, wherein the first material has a first thermal contraction property; and
a recessed area located in second component to receive the protrusion of the first component, wherein the second component is comprised of a second material, wherein the second material has a second thermal contraction property, wherein the second component has an opening where a portion of the first component is inserted into at room temperature;
wherein the second thermal contraction property is larger than the first thermal contraction property;
when at cryogenic temperatures, the first component and second component constrict, wherein the second component constricts more than the first component causing the second component to exert a constricting force on the portion of the first component inserted into the opening of the second component.

7. The apparatus of claim 6, wherein the second component exerts a constricting force on three sides of the portion of the first component.

8. The apparatus of claim 6, wherein the second component exerts a constricting force on four sides of the portion of the first component.

9. The apparatus of claim 6, wherein the first material can be selected for a group consisting of Silicon, Tungsten, Niobium, or another suitable material.

10. The apparatus of claim 9, wherein the second material can be selected from a group consisting of Copper, aluminum, or another suitable material.
